(19) United States
(12) Patent Application Publication
(10) Pub. No.: US 2008/0074874 A1
(43) Pub. Date: Mar. 27, 2008

(54) LIGHTING SYSTEMS

(76) Inventors: Peter Bradshaw, Culpeper, VA (US); Oleh Sharanevych, Green Village, NJ (US); Jon Connell, Bronx, NY (US)

Correspondence Address: KENYON & KENYON LLP, 1500 K STREET N.W., SUITE 700, WASHINGTON, DC, 20005, US

(21) Appl. No.: 11/860,284

(22) Filed: Sep. 24, 2007

Related U.S. Application Data
(60) Provisional application No. 60/846,454, filed on Sep. 22, 2006.

(51) Int. Cl. F21V 21/00; F21V 29/00; F21V 7/00; H05B 41/38

(52) U.S. Cl. 362/235; 315/360; 362/249

(57) ABSTRACT

A lighting system, and method for using same, including a light source with one or more LEDs and a controller in communication with and adapted to control power flow to the light source. The LEDs may be overdriven by the controller in a flash setting so as to achieve a luminosity of approximately 1000% of their rated output for a short duration, and in another setting overdriven in a continuous mode so as to achieve a luminosity of approximately 250% their rated output.

### RELATED APPLICATIONS

This application claims the benefit of U.S. Provisional Application No. 60/846,454, filed Sep. 22, 2006, the entire contents of which are hereby expressly incorporated herein by reference thereto.

### FIELD OF THE INVENTION

The present application relates to lighting systems and methods for using the same. More particularly, the present application relates to LED lighting systems, and methods for their use, e.g., photography and film.

### BACKGROUND INFORMATION

In the area of photography and film, current lighting systems typically use multiple light sources to illuminate a photographic subject. For example, an incandescent or high intensity discharge lamp (e.g., HMI lamp) may be used to deliver continuous illumination of the photographic subject for still photographs or filming. As it may be difficult to work under the intense light of the discharge lamp, the lamp may also be used at a lower intensity so as to provide preview lighting sufficient for proper set-up or arrangement of a photographic subject. It is also known to use an annular lighting xenon discharge tube arranged around the high intensity discharge lamp for flash purposes, i.e., to allow capture of a photographic subject in motion. The xenon discharge tube may be energized for short durations with high energy electrical pulses so as to produce high illumination levels, i.e., in flash mode.

The use of different light sources in a single photographic light system presents drawbacks. For example, given that one type of light source type is typically used in preview mode to set-up a photographic subject, and a different type of light source type is typically used for the flash, the preview mode of existing systems is not 100% indicative of how the photographic subject will look in an action shot illuminated with the flash light source.

Another drawback to existing photographic lighting systems is their high power consumption. Both the high intensity discharge lamps and the Xenon discharge tube exhibit poor efficiency characteristics with respect to power consumption.

In order to address these drawbacks, one exemplary embodiment of the present invention provides for a photographic lighting system, and methods for using the same, including one or more LEDs, e.g., operable in multiple operational states such as preview, continuous, and pulsed-light (e.g., flash) states. LEDs are more efficient than conventional light sources, thus increasing the efficiency of lighting system. Further, limiting the light system to a single light source type, e.g., one or more LEDs, assures a preview mode with 100% modeling accuracy.

### SUMMARY

A lighting system according to an exemplary embodiment of the invention includes a light source having one or more LEDs and a controller in communication with and adapted to control the powering of the LEDs. The controller has a plurality of preset light source operation modes including: (i) a flash mode in which the one or more LEDs are overdriven by the controller so as to achieve a luminosity of at least approximately 1000% of their rated output for a predetermined period of time, e.g., 30 milliseconds, and (ii) a continuous mode in which the one or more LEDs are overdriven by the controller so as to achieve a continuous luminosity of at least approximately 250% of their rated output.

In an exemplary embodiment, the controller may include a second continuous mode wherein the one or more LEDs are operated at a lower light intensity than in the first continuous mode and are not overdriven to achieve this lower light intensity.

LEDs are rated by the manufacturer at a specific current and voltage so as to assure the longevity of the LED. The controller may be configured to overdrive LEDs by increasing the voltage or current delivered to the LEDs beyond the manufacturer specifications or ratings so as to achieve greater illumination, which is necessary for many photographic applications. For example, if a Lamina Titan Turbo™ NT-54DO-487 light engine is used, overdriving the LEDs involves driving the LEDs beyond the manufacturer's recommendation of 10.8V@5A (which provides an output illumination of approximately 2000 lm).

In an exemplary embodiment, the one or more LEDs may be arranged around a periphery of the light source. Further, the one or more LEDs may be arranged so as to direct light in a direction away from a central longitudinal axis of the light source.

In an exemplary embodiment, the LEDs are mounted on a metallic support body. The support body may have fins, so as to facilitate cooling of the LEDs, and/or may be hollow and include a central passageway.

In an exemplary embodiment, the lighting system may include a cooling system adapted to cool the one or more LEDs.

In an exemplary embodiment, the lighting system may include a diffuser disposed about the light source.

In an exemplary embodiment, the lighting system may include a reflector disposed about the light source.

In an exemplary embodiment, the body supporting the LEDs may be adapted to connect to a light head.

In an exemplary embodiment, the lighting system controller may include means for selection of the plurality of preset light source operation modes such as a dial, button, sliding lever, touch screen, keyboard, etc.

Another exemplary embodiment of the lighting system of the present invention may include a light source with a plurality of LEDs, a body, a diffuser, a reflector, and a controller. The body may have at least three sides and a central longitudinal axis, at least one of the plurality of LEDs may be mounted on each of the at least three sides of the housing and directed so as to project light in a direction away from the central longitudinal axis. The diffuser may be disposed about the light source and adapted to diffuse the light produced by the LEDs. The reflector may be disposed about the diffuser and adapted to direct light produced by the LEDs in a direction along the central longitudinal axis. The controller may be in communication with and adapted to control the powering of the plurality of LEDs.

An exemplary method for operating a lighting system according to the present invention includes: (i) operating the light source at a point in time in a first setting in which the LEDs are overdriven by the controller so as to achieve a luminosity of at least approximately 1000% of their rated output for a predetermined amount of time, e.g., 30 milliseconds; and (ii) operating the light source at another point in time in a second setting in which the LEDs are overdriven by the controller so as to achieve a luminosity of at least approximately 250% of their rated output. The method may further include the preliminary step of using the LEDs to illuminate the subject without overdriving the LEDs. The method may further include the step of cooling the LEDs.

An exemplary method for capturing an image of an illuminated subject according to the present invention includes: (i) illuminating the subject using one or more LEDs, the LEDs being overdriven so as to achieve a luminosity exceeding their rated output, e.g., at least 250% or at least 1000% their rated outputs, for a predetermined period of time, e.g., 30 milliseconds, and (ii) capturing an image of the illuminated subject, e.g., digitally or using film, etc.

In an exemplary embodiment of the present invention, the LEDs may also be used to illuminate the subject without overdriving the LEDs prior to capturing the image of the illuminated subject.

The application may be embodied by numerous other devices and methods. The description provided herein, when taken in conjunction with the annexed drawings, discloses examples of the application. Other embodiments, which incorporate some or all steps as taught herein, are also possible.

### BRIEF DESCRIPTION OF THE DRAWINGS

Referring to the drawings, which form a part of this disclosure:

FIG. 1 is a side view of a lighting system according to an exemplary embodiment of the present application;

FIG. 2 is a front view of the light source separated from the lighting system illustrated in FIG. 1;

FIG. 3 is a perspective view of the light source of FIG. 2;

FIG. 4 is a front view of the light source of FIG. 1 separated from the lighting system with the light distribution from the light source illustrated schematically;

FIG. 5 is a side view of a lighting system according to another exemplary embodiment of the present application;

FIG. 6 is a top view of a light source according to another exemplary embodiment of the present application;

FIG. 7 is a perspective view of the light source of FIG. 6;

FIG. 8 is a side view of a lighting system according to an exemplary embodiment of the present application including the light source of FIG. 6;

FIG. 9 is a side view in partial cross-section of the exemplary lighting system of FIG. 1 showing a ventilation system and electrical components as may be employed with certain exemplary embodiments of the present application;

FIG. 10 is a side view of the lighting system of FIG. 1 with a reflector positioned thereon; and

FIG. 11 is a perspective view of a controller for controlling the lighting systems described herein as may be employed with certain exemplary embodiments of the present application.

### DETAILED DESCRIPTION

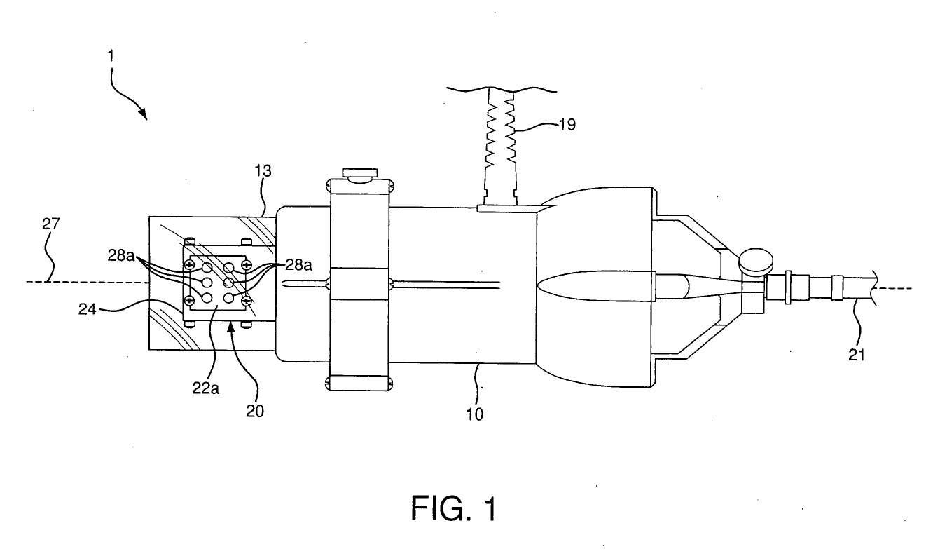

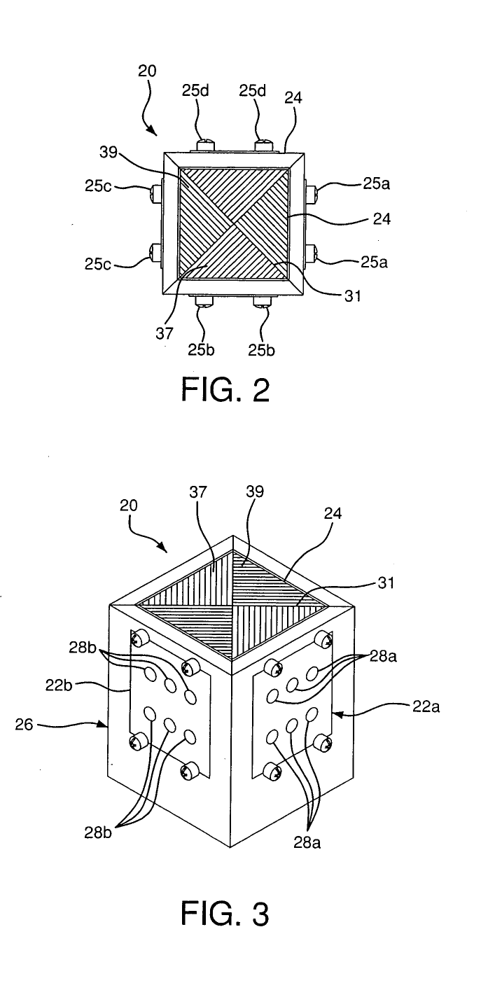

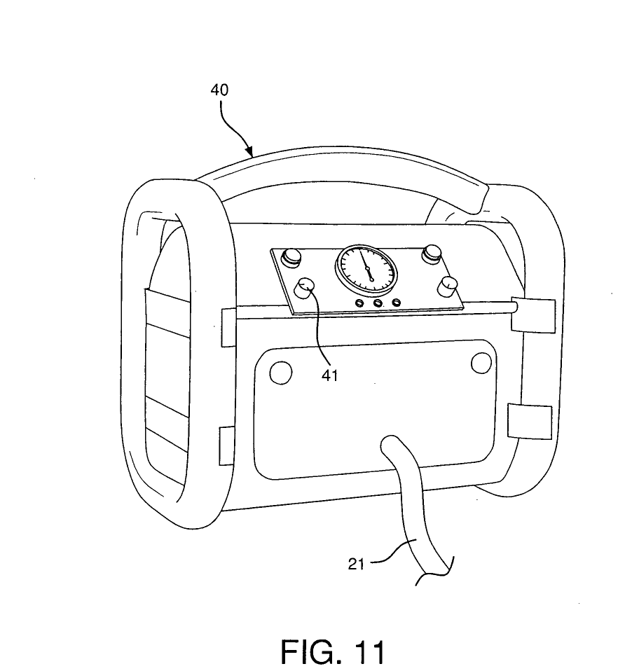

Referring to FIGS. 1 to 3, a lighting system 1 is shown including a housing 10 and a light source 20 mounted on the housing 10 including a body 24 (FIGS. 2 and 3) and four light engines 22a, 22b, 22c (hidden from view), and 22d (hidden from view) secured to the body 24. Each of the light engines 22a, 22b, 22c, and 22d includes one set of LEDs 28a, 28b, 28c (hidden from view), or 28d (hidden from view). The light source 20 may be electronically connected to a controller 40 (FIG. 11) for controlling the light source 20 via, e.g., a cable 21, as further detailed below. A cylindrical diffuser element 13 is disposed about the light source 20. The diffuser 13, which may be glass, is used to protect the light source 20 and to facilitate light distribution.

The housing 10 is generally cylindrical and includes spacing for receiving various components, for example, components for ventilation and to electrically connect the device to a power source and/or controller. Conventional “light heads” used for xenon and HMI systems, as are well known in the field of photographic lighting, are suitable for use as the housing 10. A securing member 19 may be used to secure the lighting system 1 into a mounting assembly. The housing 10 may include a cooler in contact or close proximity to the light source 20 or a ventilation system which circulates warm air away from the light source 20 or blows cooler air in the direction of the light source 20.

The exemplary embodiment of the light source 20 illustrated in FIGS. 2 and 3 is box shaped, however, any suitable shape may be used. For example, the light source 20 may be triangular, circular and/or irregularly shaped. Light source 20 may be arranged with any number of sides, for example a three-sided element, five-sided element (as described in further detail below), a six-sided element and so on. For example, n-number of light engines 22 may be used, where n may be any suitable integer. Further, the light engines 22 may be located around a curved support, e.g., a dome or ring shaped heat sink support.

As seen in FIGS. 2 and 3, the light source 20 is comprised of a body 24 and one or more light engines 22a, 22b, 22c (hidden from view in FIG. 3), and 22d (hidden from view in FIG. 3) mounted onto the body 24, e.g., via screws 25a, 25b, 25c, and 25d. However, other known arrangements for securing LEDs, e.g., to heat sinks, may be used. The LEDs 28a, 28b, 28c, and 28d are positioned so as to direct light in a direction away from a central axis 27 (FIG. 1) of the light system 1 or light source 20.

In another embodiment, the angle of inclination of the light source 20 relative to its central axis 27 (FIG. 1) may be titled to provide varying degrees of illumination efficiency. Further, tilting or otherwise adjusting the angle of inclination may be utilized for satisfying illumination or other types of requirements for different illumination systems.

As is seen in FIGS. 2 and 3, the body 24 is square shaped; however, as discussed above, it can be any of a number of sizes and/or shape. Likewise, the body 24 may be hollow, solid, and/or combinations thereof. In the example embodiment of FIG. 1, the interior of body 24 is occupied by a rectangular shaped finned heat sink element 31, which may form an integral part of body 24 or fill a hollow central passageway of body 24. The heat sink element 31 is made from a material exhibiting high thermal conductivity, such as aluminum, and acts to draw away heat generated by light engines 22a, 22b, 22c, and 22d. Heat sink element 31 may extend the entire length of body 24 or only along a portion of its length.

Passageways 37 formed between fins 39 of heat sink element 31 may be in communication with a ventilation system, described in more detail below, which can blow or draw air past the fins 39 to cool the light source 20. Providing increased airflow over the fins 39, a larger temperature gradient may be maintained by replacing the warmed air more quickly than passive convection would alone.

As is seen in FIG. 3, each of the light engines 22a, 22b, 22c, and 22d include one set of multiple LEDs 28a, 28b, 28c (hidden from view), or 28d (hidden from view). Any suitable light engine may be used, such as the TITAN TURBO™ light engine commercially available through LAMINA™ Corporation. Other suitable examples of light engines include high powered white-light LED assemblies manufactured by CITIZEN ELECTRONICS™ CO., LTD and OSRAM™ Gmbh.

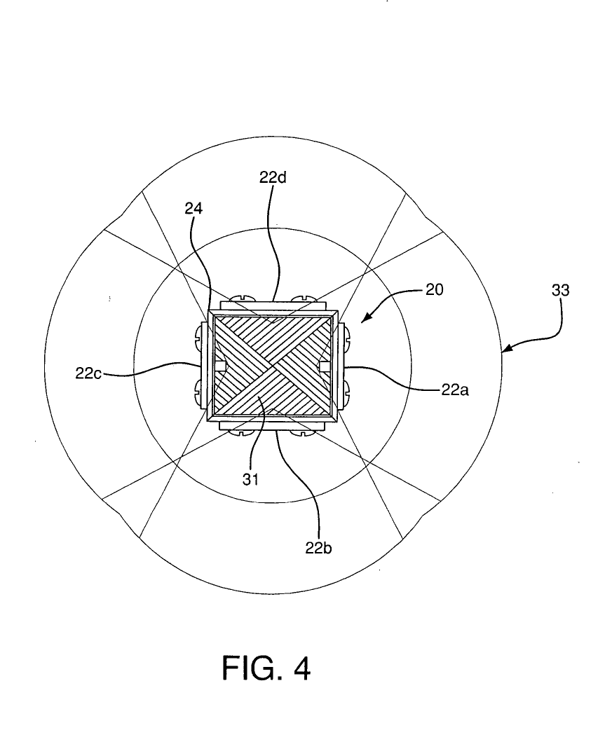

The light distribution 33 generated by the light engines 22a, 22b, 22c, and 22d is schematically illustrated in FIG. 4. In the embodiment of FIG. 4, the four-sided light source has four light engines 22a, 22b, 22c, and 22d that outwardly distribute illumination. As described in further detail below, when the light source 20 is disposed within a reflector 1016 (FIG. 10), the illumination is thereupon efficiently forwardly directed.

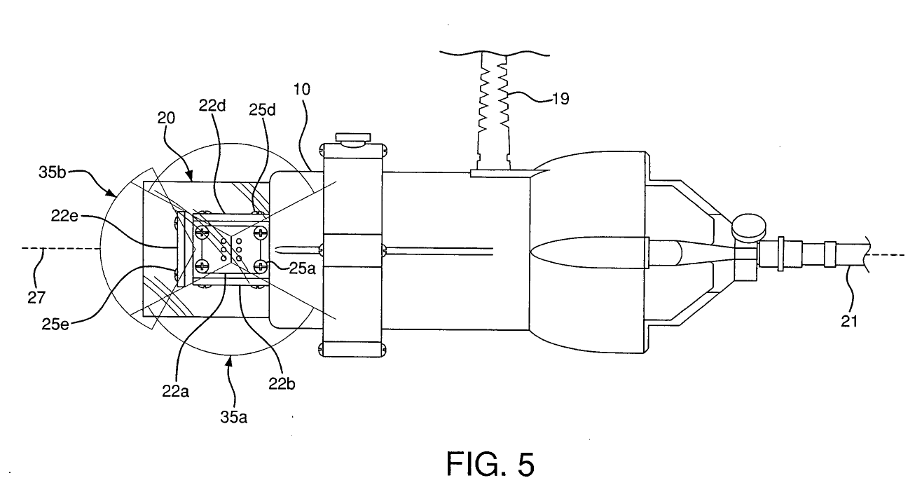

FIG. 5 is a side view of another exemplary embodiment of the present invention identical to that illustrated in FIG. 1 except for the addition of a fifth light engine 22e located on the front of the light source 20. Light engine 22e may be secured to body 24, e.g., via a plurality of screws 25e. The light generated by light source 20 in the embodiment of FIG. 4 has two components, an outwardly extending illumination 35a, which is annularly generated by light engines 22a, 22b, 22c, and 22d, and a forward generated non-reflective portion 35b, generated by the front light engine 22e.

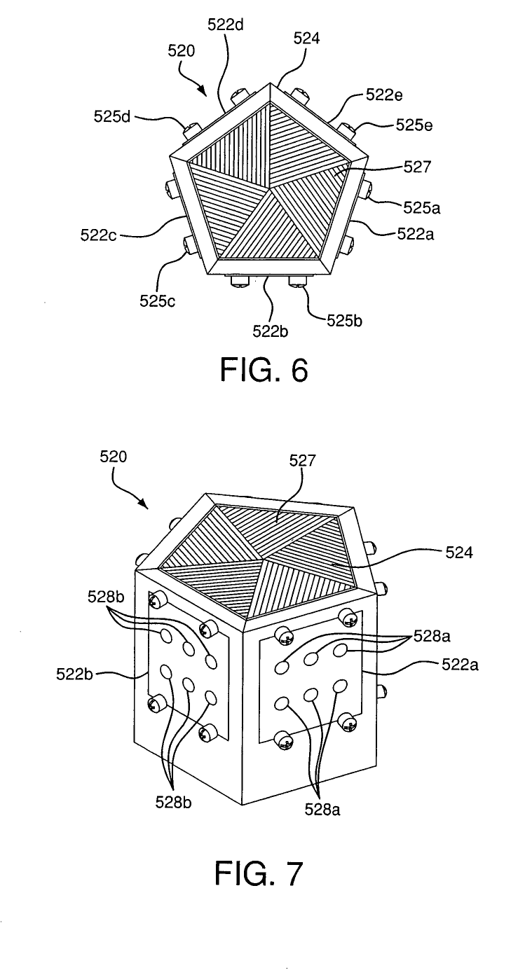

FIGS. 6 to 8 illustrate an exemplary embodiment of five sided light source 520, including five light engines 522a, 522b, 522c, 522d, and 522e disposed around the light source 520. FIG. 6 is a front view of the body 524 of the light source 520 and shows the equal disposition of the light engines 522a, 522b, 522c, 522d, and 522e, whereas FIG. 7 illustrates a perspective view of the five-sided light source 520. Each of the light engines 522a, 522b, 522c, 522d, and 522e includes one set of LEDs 528a, 528b, 528c (hidden from view), 528d (hidden from view), or 528e (hidden from view), and is secured to the body 524, e.g., by one set of screws 525a, 525b, 525c, 525d, or 525e, respectively. A finned heat sink element 527 runs down a channel defined by the body 524 and either slides into the body 524 or is integral with body 524.

As with the embodiment of FIG. 1 to 3, heat sink element 527 and body 524 may be made from a material with a high thermal conductivity so as to draw heat away from light engines 522a, 522b, 522c, 522d, 525e. For both embodiments, various fin arrangements may be used including parallel fins running in a single direction, multiple directions, having a helical shape or radially directed, etc. In another example embodiment, the heat sink elements 31, 527 may be eliminated leaving the hollow passageway of the body 24, 524 vacant.

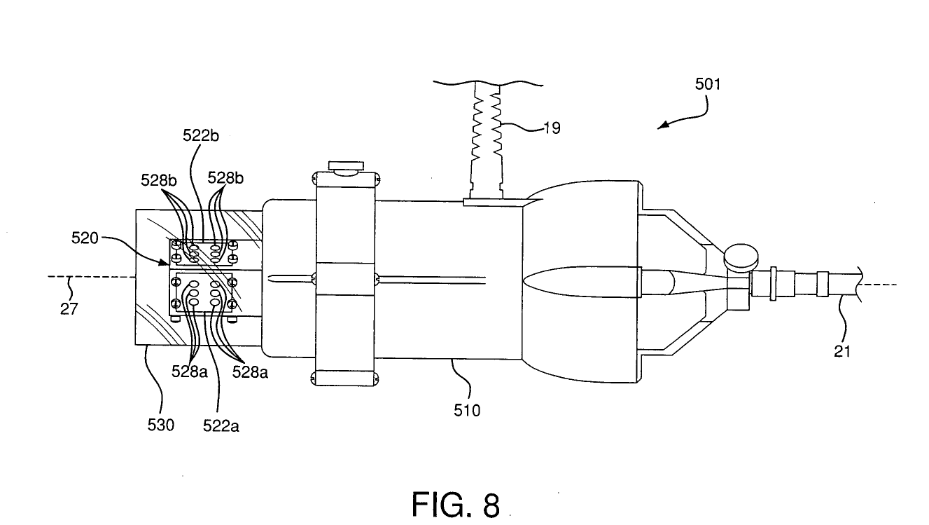

FIG. 8 illustrates a side view of an exemplary embodiment of a lighting system 501 with a light source 520 mounted on a housing 510. The light source 520 of FIG. 8, similar to the embodiment of FIGS. 6 to 7, includes the five light engines 522a, 522b, 522c, 522d, and 522e forming a light source 520 and additionally illustrates the light source 520 within a diffuser 530, which may be glass, used to protect the light source 520 and facilitate light distribution.

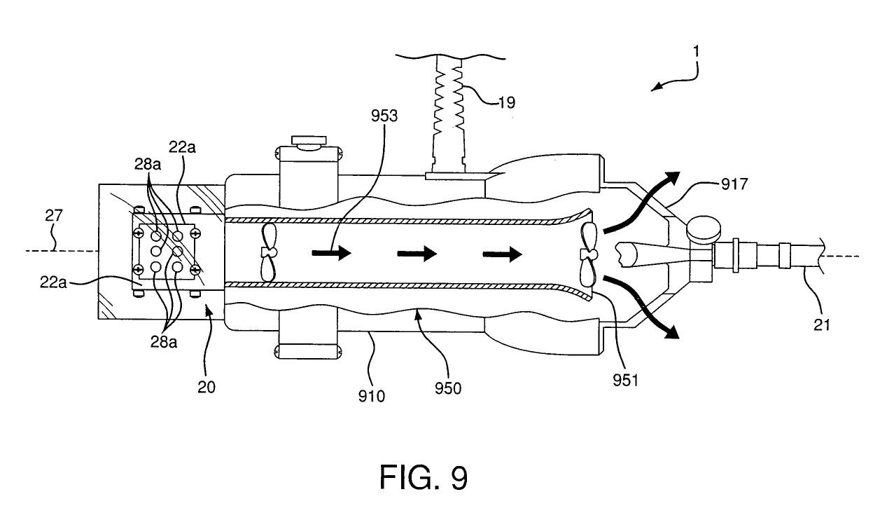

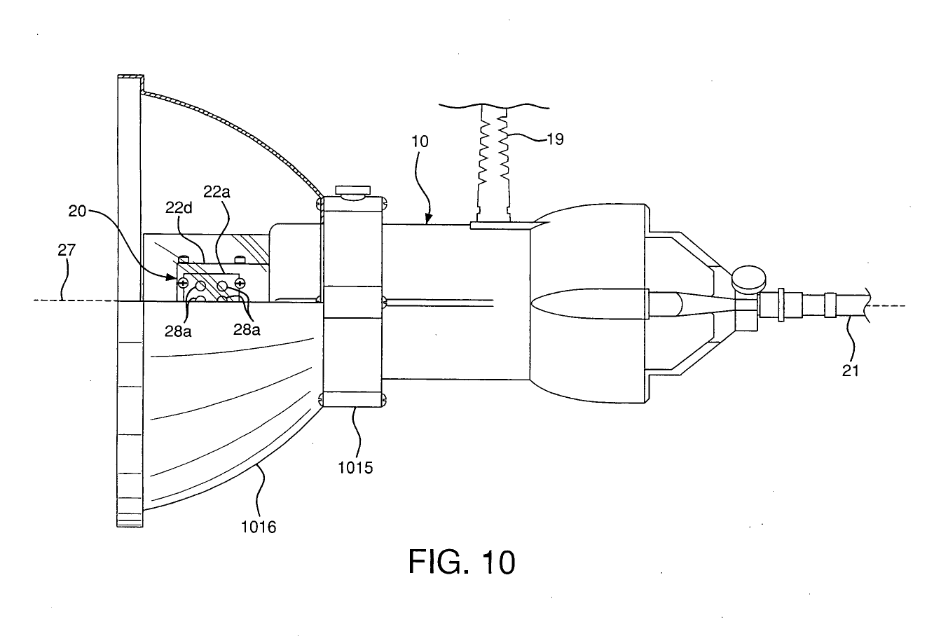

As illustrated in FIG. 9, the interior portion of lighting system 1 may include a ventilation system 950 for dissipating heat generated by the light source 20. Ventilation system 950 may include one or more fans 951, which may be used to draw warm air away in the direction of arrows 953 away from the light engines 22a, 22b, 22c, and 22d. The fans 951 draw air through body 24, 524 and out through an end 917 of the housing to provide cooling.

Alternatively, fans 951 can be used to blow air in the opposite direction past light engines 22a, 22b, 22c, and 22d. A cooler (not shown) may be used to cool the air being blown past light engines 22a, 22b, 22c, and 22d. A similar ventilation/cooling system may be used in the embodiment illustrated in FIG. 8.

Ventilation system 950 causes air to be drawn or blown into the passageways 37 formed between the heat sink fins 39. If no heat sink is used, the air is blown through the hollow chamber defined by body 24, 524. Air may also be blown on the light emitting side of the light engines 22a, 22b, 22c, and 22d. The light engines 22a, 22b, 22c, and 22d may also be inset into body 24, 524, in which case the air flow may be directly against the inner surface of the light engines 22a, 22b, 22c, and 22d, which may partially extend into the chamber of body 24, 524 or lie flush with an inner surface of the body 24, 524.

It is recognized that other suitable heat dissipation or management systems may be envisioned and utilized in the light source disclosed herein. For example, referring back to FIG. 5, in embodiments where a LED is positioned on a top surface of the light source, the ventilation system may include fins, channels, fans, and coolers disposed in the housing on an inner and/or outer surface of the light engine support body. Further, the light engines may be mounted and/or covered on/with thermally conductive coatings and layers to facilitate cooling of the device via, e.g., conduction and radiation.

Referring again to FIG. 9, the lighting system 1 may include cable 21 to electrically connect the lighting system 1, as well as the lighting source 20, to the controller 40 (FIG. 11) and to a power source. The controller 40 may also directly provide power to the light source 20 and/or ventilation system 950.

The light engines 22a, 22b, 22c, 22d, and 22e are positioned so as to emit illumination in a direction away from the central axis 27 of the light source 20. The light, however, may be reflected in a forward direction using a reflector 1016, as illustrated in FIG. 10. The reflector 1016 may be mounted using a clamping member 1015, which may be slidably positionable and tightened over the housing 10. A top portion of reflector 1016 is cut-out of the illustration so as to reveal the light source 20, light engine 22a, and LEDs 28a within.

Turning to FIG. 11, the power requirements of the light source 20 can be managed by controller 40. The controller 40 may be remotely controlled thus increasing the portability of the controller 40 and lighting system.

LEDs are rated by the manufacturer at a specific current and voltage so as to assure the longevity of the LED. Controller 40 is configured to overdrive LEDs 28a, 28b, 28c, 28d, and 28e (front LED hidden from view in the embodiment of FIG. 5) by increasing the voltage or current delivered to the LEDs beyond the manufacturer specifications or ratings so as to achieve greater illumination, which is necessary for many photographic applications. For example, if a Lamina Titan Turbo™ NT-54DO-487 light engine is used, overdriving the LEDs involves driving the LEDs beyond the manufacturer's recommendation of 10.8V@5A (which provides an output illumination of approximately 2000 lm).

In order to overdrive the LEDs 28a, 28b, 28c, 28d, and 28e, the controller 40 includes a driver (an internal component of the controller 40 which is not shown) to operate the LEDs 28a, 28b, 28c, 28d, and 28e in multiple operational states, e.g., preview, continuous, and pulsed-light states. The driver may be comprised of a plurality of electrical components to control current and voltage, as well as the duration for which each is applied. For example, the driver can include suitable combinations of voltage/current regulators, power rectifiers, converters, and frequency oscillators.

The intensity and duration of the light source 20, 520 can be adjusted by the controller 40, e.g., via a mode selection means 41. The mode selection means may include buttons or dials, which, for example, when depressed or rotated cause the LEDs to move between different levels of illumination. A button or dial may also be dedicated for controlling the duration of flash. Other examples of mode selection means include a keyboard, touch screen, sliding lever, etc. The controller 40 may also include a gauge 43 or other display device to provide the user a visual indication as to the power delivered to the light source 20, 520 or the light source mode of operation.

The controller 40 may configured to operate the light source 20, 520 in multiple preset discrete settings. In a first setting, i.e., a pulsed-light or flash mode, the LEDs may be overdriven by the controller 40 so as to achieve a luminosity of 40,000-50,000 lumens, which corresponds to at least approximately 1000% of the LED's rated output, for a flash period of, e.g., approximately 30 milliseconds. This setting is appropriate, e.g., for action shots.

In a second setting, the LEDs may be operated in a continuous mode in which the LEDs are overdriven by the controller so as to achieve a luminosity of approximately 7,000-12,000 lumens, which corresponds to at least approximately 250% of the LED's rated output. This setting is appropriate, e.g., for still photography.

In a third setting, i.e., a preview mode, the LEDs are operated at a lower light intensity, e.g., about 1/20 of the light output of the continuous mode and 1/100 of the light output of the flash mode. This mode may be useful to provide lighting sufficient to set up a photographic subject prior to use of the brighter continuous and flash modes.

Using embodiments of the present application, a user can operate the preview mode, e.g., to set-up a photographic subject, and then transition using the mode selection means 41 to the flash or continuous settings to take action and still shots, all using a single light source type to enable 100% modeling accuracy.

In an alternative exemplary embodiment, rather than a discrete number of settings, a dial (similar to that used in a dimmer light) or other input device, e.g., a keyboard, touch screen, sliding lever etc., may be included on the controller 40 to provide the user with an infinite number of intensity options. For example, one dial may be provided to control the intensity of the continuous illumination mode and another dial may provided to control the intensity of the flash mode. Similarly, the user may also be provided with a dial to control the flash duration.

The examples described herein are merely illustrative, as numerous other embodiments may be implemented without departing from the spirit and scope of the exemplary embodiments of the present application. Moreover, while certain features of the application may be shown on only certain embodiments or configurations, these features may be exchanged, added, and removed from and between the various embodiments or configurations while remaining within the scope of the application. Likewise, methods described and disclosed may also be performed in various sequences, with some or all of the disclosed steps being performed in a different order than described while still remaining within the spirit and scope of the present application.

What is claimed is:

1. A lighting system, comprising:
a light source including one or more LEDs; and
a controller in communication with and adapted to control the powering of the LEDs,
wherein the controller has a plurality of preset light source operation modes including a flash mode in which the one or more LEDs are overdriven by the controller so as to achieve a luminosity of at least approximately 1000% of their rated output for a predetermined period of time, and a continuous mode in which the one or more LEDs are overdriven by the controller so as to achieve a continuous luminosity of at least approximately 250% of their rated output.

2. The lighting system of claim 1, wherein the predetermined amount of time is approximately 30 milliseconds.

3. The lighting system of claim 1, wherein the controller includes a second continuous mode wherein the one or more LEDs are operated at a lower light intensity than in the first continuous mode and are not overdriven to achieve this lower light intensity.

4. The lighting system of claim 1, wherein the one or more LEDs are arranged around a periphery of the light source.

5. The lighting system of claim 4, wherein the one or more LEDs are arranged so as to direct light in a direction away from a central longitudinal axis of the light source.

6. The lighting system of claim 1, wherein the LEDs are mounted on a metallic support body.

7. The lighting system of claim 6, wherein the support body has fins.

8. The lighting system of claim 6, wherein the support body is hollow and includes a central passageway.

9. The lighting system of claim 1, further comprising a cooling system adapted to cool the one or more LEDs.

10. The lighting system of claim 1, further comprising a diffuser disposed about the light source.

11. The lighting system of claim 1, further comprising a reflector disposed about the light source.

12. The lighting system of claim 1, wherein the controller includes means for selection of the plurality of preset light source operation modes.

13. A lighting system, comprising:
a light source including a plurality of LEDs and a body, the body having at least three sides and a central longitudinal axis, at least one the plurality of LEDs mounted on each of the at least three sides of the housing and directed so as to project light in a direction away from the central longitudinal axis;
a diffuser disposed about the light source adapted to diffuse the light produced by the LEDs;
a reflector disposed about the diffuser adapted to direct light produced by the LEDs in a direction along the central longitudinal axis; and
a controller in communication with and adapted to control the powering of the plurality of LEDs.

14. The lighting system of claim 10, wherein the body is metallic.

15. The lighting system of claim 10, further comprising a cooling system configured to cool the body.

16. The lighting system of claim 10, wherein the body is adapted to connect to a light head.

17. A method for operating a lighting system comprising a light source, including one or more LEDs, and a controller in communication with and adapted to control powering of the light source, comprising the steps of:
operating the light source at a point in time in a first setting in which the LEDs are overdriven by the controller so as to achieve a luminosity of at least approximately 1000% of their rated output for a predetermined amount of time; and
operating the light source at another point in time in a second setting in which the LEDs are overdriven by the controller so as to achieve a luminosity of at least approximately 250% of their rated output.

18. The method of claim 17, wherein the predetermined amount of time is approximately 30 milliseconds.

19. The method of claim 17, further comprising the preliminary step of using the LEDs to illuminate the subject without overdriving the LEDs.

20. The method of claim 17, further comprising the step of cooling the LEDs.

21. A method for capturing an image of an illuminated subject, comprising:
illuminating the subject using one or more LEDs, the LEDs being overdriven so as to achieve a luminosity exceeding their rated output for a predetermined period of time; and
capturing an image of the illuminated subject.

22. The method of claim 21, wherein the LEDs are overdriven so as to achieve a luminosity of at least 1000% their rated output.

23. The method of claim 21, wherein the LEDs are overdriven so as to achieve a luminosity of at least 250% their rated output.

24. The method of claim 22, wherein the LEDs are overdriven for a period of approximately 30 milliseconds.

25. The method of claim 21, further comprising the preliminary step of using the LEDs to illuminate the subject without overdriving the LEDs.
